(19) United States
(12) Patent Application Publication
(10) Pub. No.: US 2012/0296519 A1
(43) Pub. Date: Nov. 22, 2012

(54) Crane Control

(75) Inventors: Johannes Karl Eberharter, Satteins (AT); Klaus Schneider, Hergatz (DE); Eugen Schobesberger, Rothis (AT); Helmut Fischer, Bludesch (AT)

(73) Assignee: Liebherr-Werk Nenzing Ges.m.b.H., Nenzing (AT)

(21) Appl. No.: 13/475,313

(22) Filed: May 18, 2012

(30) Foreign Application Priority Data
May 19, 2011 (DE) 102011102025.3

(51) Int. Cl. B63B 27/10; B66C 13/16

(52) U.S. Cl. 701/34.4

(57) ABSTRACT

The present invention relates to a crane control for a crane arranged on a ship, having a load moment limitation system which determines a maximum permitted payload, wherein the load moment limitation system is in communication with a measuring unit for measuring the movement of the ship and determines the maximum permitted payload on the basis of data of the measuring unit.

### BACKGROUND OF THE INVENTION

The present invention relates to a crane control for a crane arranged on a ship having a load moment limitation system which determines a maximum permitted payload. The load moment limitation system can in this respect either take account of the maximum permitted payload in an automated manner in the control of the crane or can output it to the user so that he can take account of the maximum permitted payload in the control of the crane.

With a crane arranged on a ship, in addition to the usual factors which are taken into a load moment limitation system such as the outreach of the crane, it must furthermore be taken into account on the determination of the maximum permitted payload that the current wave movement can also have effects on the maximum permitted payload. Previous load moment limitation systems in which a significant wave height or a sea state is determined according to which a corresponding payload curve has to be selected in crane operations are subject to great uncertainties in this respect.

### SUMMARY OF THE INVENTION

It is therefore the object of the present invention to provide a crane control having a load moment limitation system which allows a more reliable determination of the maximum permitted payload of a crane arranged on a ship.

This object is achieved in accordance with the invention by a crane control in accordance with the description herein.

The present invention in this respect shows to a crane control for a crane arranged on a ship having a load moment limitation system which determines a maximum permitted payload. In this respect, the load moment limitation system is in communication with a measuring unit for measuring the movement of the ship and determines the maximum permitted payload on the basis of data of the measuring unit.

Whereas in accordance with the prior art a conclusion was drawn on the movement of the boom tip from the significant wave height, which can anyway only be determined with difficulty, and the maximum payload limit was in turn determined from said movement so that e.g. the onflow direction and the ship type were not able to be taken into account, the ship movements are now detected by sensors and are used for determining the maximum payload of the crane. The technical limits can thus be utilized in a manner which better satisfies the situation by the measurement of the real ship movement and thus higher payloads can be achieved with an unchangingly high reliability.

In particular an inertia measuring system is used as the measuring unit in this respect from whose data the movement of the boom tip of the crane can be determined at least in the vertical direction on the basis of the ship's movement. The measuring unit can in this respect in particular include a gyroscope and/or an accelerometer and/or an electronic inclinometer. The load moment limitation system advantageously determines a speed and/or acceleration of the boom tip by the evaluation of data of the measuring unit and determines the maximum permitted payload from this. In this respect, at least the speed and/or acceleration of the boom tip in the vertical direction is advantageously determined and the maximum permitted payload is determined from this. The determination of the vertical movement of the boom tip is in this respect usually sufficient to determine the maximum permitted payload since this represents the decisive factor in the movement of the boom tip with respect to the payload.

In the crane control in accordance with the invention, the determination of the speed and/or acceleration of the boom tip advantageously takes place on the basis of data of a preceding specific time period. The determination thus always takes place via a specific concurrent time window so that current data are always used for determining the speed and/or acceleration or for determining the maximum permitted payload.

Furthermore, provision can be made in the present invention that an initializing of the load moment limitation system using currently measured values takes place at the start of work. The starting results are in this respect always based on values since the restart of the control, whereas old data are not taken into account for the calculation.

The load moment limitation system advantageously determines a tip speed and/or tip acceleration of the boom tip over a specific time period. This can then be used for determining the maximum permitted payload.

The determination of the tip speed and/or tip acceleration in this respect advantageously takes place via a filtering algorithm which evaluates the measured data of the measuring unit.

Further advantageously, the load moment limitation system forms a mean value of the speed and/or acceleration of the boom tip over a specific time period. The mean value formation in this respect advantageously takes place in this respect over an upper part region of the speeds and/or accelerations determined by the measuring unit. An averaged tip speed and/or tip acceleration hereby result(s). For example, the mean value of the upper third of the measured speeds and/or accelerations can in this respect be determined in accordance with the invention.

Further advantageously, the maximum permitted payload is read out of a table or of a look-up table in accordance with the invention with reference to a speed value and/or acceleration value determined from the data of the measuring unit. The maximum permitted payloads for different speed values and/or acceleration values can therefore be stored in the crane control in accordance with the invention in the form of a table and can then be read out in accordance with the values determined. The table can naturally be a multidimensional table so that further values can naturally also be taken into the interrogating of the maximum permitted payload in addition to the speed values and/or acceleration values. The outreach of the crane can in particular still be taken into the interrogating of the table in this respect. Alternatively, the payload can also be calculated online. To the extent that reference is made to the reading out of tables in the following description, an online calculation can alternatively also respectively be carried out here.

In a first embodiment of the present invention, the measuring unit can be arranged at the crane tip. The measuring unit can thus directly measure the movement of the crane tip by the wave movement of the ship. The measuring unit is in this respect in particular equipped so that it can determine the movement of the crane tip in the vertical direction, in particular the speed and/or acceleration and/or of the crane tip in the vertical direction. The crane control advantageously in this respect has an evaluation unit which calculates the movements of the boom tip produced by the crane movement from the total movement measured by the measuring unit.

Furthermore, a determination of the speed and/or acceleration of the boom tip for a specific boom position can take place by conversion of data of a measuring unit not arranged in this position. In this respect, a position for which the maximum payload should be determined no longer has to be moved to by the boom.

Provision can furthermore be made in accordance with the invention that a measuring unit is arranged at the tower of the crane or at the ship, with the load moment limitation system determining the speed and/or acceleration of the boom tip by converting the data from the measuring unit. A geometrical model of the crane is advantageously used for this purpose. Further advantageously, data on a current and/or a virtual position of the boom tip are in this respect taken into the calculation.

Provision can advantageously be made in accordance with the present invention that the determination of the speed and/or acceleration of the boom tip takes place for a boom position which can be input by the user. The crane control in accordance with the invention therefore in particular includes a user dialog in which the user can input a boom position for which then the maximum permitted payload is determined. The determination of the speed or of the acceleration is thus possible for any desired position of the boom tip without having to move to it.

If a measuring unit is used which is not arranged at the crane tip, it advantageously determines the speed and/or acceleration in all three spatial directions. The vertical speed and/or acceleration of the boom tip decisive for the payload can then be calculated from the measured values of this measuring unit. This vertical movement is then taken into the determination of the maximum permitted payload. The two named measuring units can advantageously also be combined.

Horizontal influences can advantageously additionally be taken into account. They can be based on an inclined position of the ship resulting from the load state or from a pre-trim. Dynamic horizontal deflections of the load caused by relative horizontal movements of the installations (ship with crane, ship where the load decreases and increases) are also taken into account here. In this respect, the horizontal influences can be measured or calculated. The values can be taken into account in the payloads by tables or by online calculation.

Provision can furthermore be made that the load moment limitation system in accordance with the invention is in communication with a second measuring unit which determines the movement of a further ship, with the load moment limitation system additionally making use of data of the second measuring unit for determining the maximum permitted payload. This embodiment of the crane control in accordance with the invention can in particular be used when a load should be placed on a further ship or should be taken up by it. In this case, the movement of the this further ship is also a factor which has to be taken into account in the maximum permitted payload. This is effected in accordance with the invention by a second measuring unit which is arranged on the further ship.

The evaluation of the data of the second measuring unit can in this respect take place in the same manner as for the data of the first measuring unit. In this respect, in particular a tip speed and/or tip acceleration of the further ship can be determined. A mean value of the speed and/or acceleration over a specific time period can advantageously be formed for this purpose. The mean value formation in this respect advantageously takes place over an upper part region of the speeds and/or accelerations determined by the measuring unit. A filtering of the measured data can furthermore previously take place.

The crane control in accordance with the invention advantageously has an output unit which outputs the maximum payload calculated by the load moment limitation system. It is in this respect advantageously an optical output unit, in particular a display unit. The output can additionally or alternatively also take place to the crane control which takes it into account automatically in the control of the crane.

Provision can in this respect advantageously be made that the output of the maximum permitted payload for a specific boom position is possible. Such a boom position can advantageously be input by the user in this respect.

Alternatively or additionally, provision can be made that the maximum permitted payload is output as a payload curve.

In addition to the crane control, the present invention furthermore includes a crane having a crane control in accordance with the invention. It is in particular a boom crane in this respect. It is further advantageously a revolving tower crane—such as a revolving boom crane, offshore crane, ship crane or a non-revolvable luffable frame gantry crane—having a tower which is rotatable about a vertical axis of rotation and at which a boom is arranged. The crane control in this respect advantageously controls the hoisting gear of the crane in accordance with the invention. The crane in accordance with the invention is in this respect arrangeable or arranged on a ship.

In addition to the crane control and the crane, the present invention furthermore includes a ship having a crane in accordance with the invention which is accordingly equipped with a crane control in accordance with the invention.

The present invention furthermore includes a method for operating a crane arranged on a ship in which a maximum permitted payload is determined. Provision is advantageously made for this purpose that a movement of the ship is measured and the maximum permitted payload is determined on the basis of the measured movement. The determination of the maximum permitted payload in this respect advantageously takes place such as was already described above with respect to the crane control. In this respect, a speed and/or acceleration of the boom tip, in particular in the vertical direction, is in particular advantageously determined by means of the measured data and the maximum permitted payload is determined from it.

The present invention furthermore includes a program, in particular a program stored on a data carrier, for implementing a method such as was presented above on a crane control.

### BRIEF DESCRIPTION OF THE DRAWINGS

The present invention will now be presented in more detail with reference to embodiments and to drawings.

There are shown:

FIG. 1 an embodiment of a ship in accordance with the invention with a crane in accordance with the invention having a control unit in accordance with the invention;

FIG. 2 a schematic diagram of a first embodiment of a crane control in accordance with the invention;

FIG. 3 an input and output unit for a crane control of a second embodiment of the present invention;

FIG. 4 an output unit for a crane control of a third embodiment of the present invention;

FIG. 5 a schematic diagram of a fourth embodiment of a crane control in accordance with the invention;

FIG. 6 a schematic diagram of a fifth embodiment of a crane control in accordance with the invention; and

FIG. 7 a schematic diagram of a sixth embodiment of a crane control in accordance with the invention.

### DESCRIPTION OF THE PREFERRED EMBODIMENTS

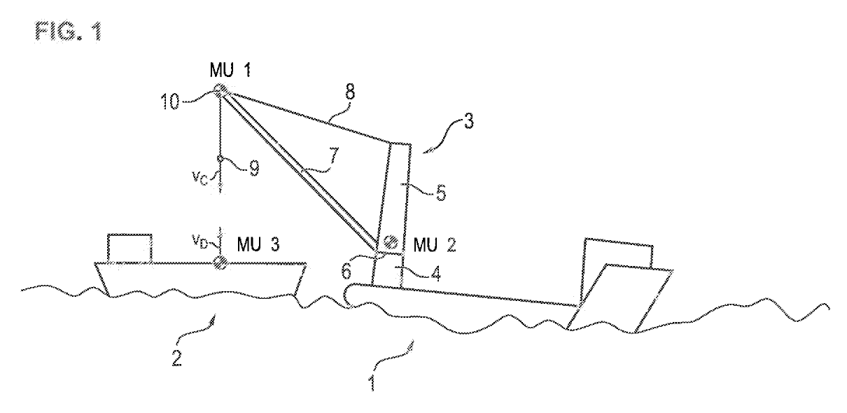

FIG. 1 shows an embodiment of a ship 1 in accordance with the invention. The ship 1 in this respect has a crane 3 which is equipped with a crane control in accordance with the invention. In the embodiment, it is in this respect a revolving tower crane having a tower 5 which is rotatably arranged about a vertical axis of rotation via a slewing gear 6 on a tower base 4. A boom 7 is upwardly and downwardly luffably arranged about a horizontal axis of rotation at the tower 5. The hoist rope 8 is in this respect guided over the tip 10 of the boom 7. The crane in this respect in particular has a lifting drive for moving the hoist rope 8 via which a load suspended at the crane hook 9 can be raised. Furthermore, a further ship 2 is shown in FIG. 1 on which the load can be placed or from which the load can be raised.

As drawn in FIG. 1, the wave movement generates a movement of the ship and thus a movement v_{C} of the tip 10 of the boom and thus of the load. The wave movement equally generates a movement v_{D} of the further ship and thus of the destination. The movements of the crane generated by the wave movement have an effect on the maximum permitted payload (SWL=safe work load). In accordance with the invention, the maximum payload of the crane suitable for the situation is determined with reference to measured values which are obtained by a measuring unit for measuring the movement of the ship 1. The ship's movements detected by the sensors are in this respect processed by means of filtering algorithms in order thus to determine the vertical boom tip speed and/or vertical boom tip acceleration. The maximum payload of the crane suitable for the situation can subsequently be calculated using this speed and/or acceleration.

The measurement of the real ship's movement on the open seas in this respect allows the technical limits to be exploited better since the maximum payload can be determined substantially more reliably via the transmitted real movement of the boom tip in the vertical direction than by a method in accordance with the prior art.

An inertia measuring unit is advantageously used as a measuring unit MU. It can in particular include a gyroscope and/or an acceleration encoder or accelerometer and/or electronic inclinometers. In FIG. 1, three possible different positions for such a measuring unit are now given which can be used both in combination and individually in each case in accordance with the invention.

MU 1: Arrangement of the measuring unit MU 1 at the boom tip

MU 2: Arrangement of the measuring unit MU 2 at the tower of the crane or at the ship

MU 3: Arrangement of the measuring unit MU 3 on a further ship/barge

The first two positions for the arrangement of a measuring unit can in this respect be used alternatively or simultaneously to determine the movement of the boom tip on the basis of the movement of the ship 1. The third arrangement option of a measuring unit serves to determine the movement of a further ship 2 on which the load should be placed down or from which the load should be taken up.

If instead of a further ship 2 a fixed installation is used, for example a platform, the third measuring unit MU 3 is not required. The vertical speed v_{D} can rather then be assumed to be zero.

The vertical speed v_{C} in the boom tip or the acceleration of the boom tip can in contrast be measured directly by the MU 1 and/or can be calculated from the values measured by the MU 2.

The evaluation of the measured values will now be explained in more detail in a first embodiment in which the determination of the maximum payload is determined with reference to a vertical tip speed v_{C}. In this respect, the meaned vertical speed of the current position of the crane tip is determined by recording the movement of the boom tip by means of the measuring unit MU 1 and subsequent statistical evaluation over a specific time window. This vertical speed and the outreach then determine the maximum payload.

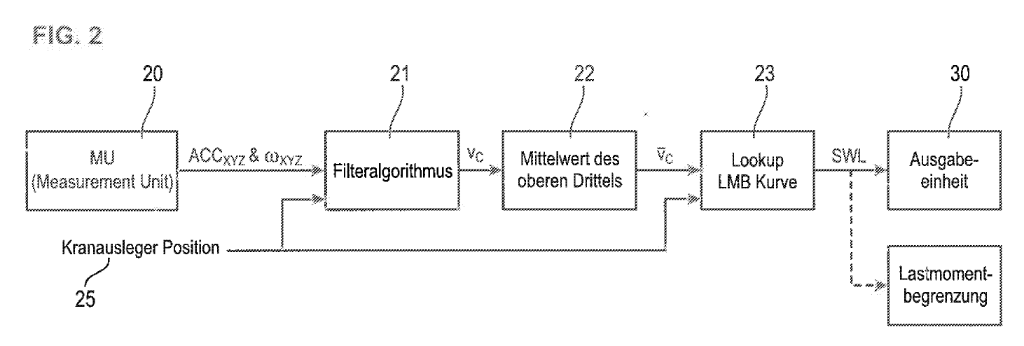

FIG. 2 in this respect shows a schematic flowchart of the evaluation: The data for the movement of the boom tip measured by the measuring unit 20 are in this respect first filtered via a filtering algorithm 21 and the current vertical speed v_{C} is determined from these. The position of the crane boom which is taken from the crane control in step 25 is in this respect advantageously taken into the algorithm 21 for calculating the vertical speed v_{C} of the boom tip from the measured data of the measuring unit 20. In step 22, the mean value of the upper third of the measured speeds v_{C} is then determined over a specific time window.

The tip speed and the outreach of the crane boom determined in step 22 are then used in step 23 to determine the maximum payload. In this respect, the maximum payload is read out of a corresponding table with reference to the values for the tip speed and for the outreach. The output of the maximum payload SWL thus determined then takes place in step 30 in a user interface.

To increase the comfort for the user, the determination of the vertical speed v_{C} of the boom tip can take place for any desired working point without this point first having to be moved to by the crane. The second measuring unit MU 2 can be used for this purpose. In this respect, any desired boom tip position can be moved to virtually via an input of the user. The vertical boom tip speed v_{C} for the virtual working point of the boom tip can now be calculated from the data determined by the measuring unit 2. For this purpose, only the known geometry of the boom tip with respect to the position of the second measuring unit MU 2 has to be used.

The evaluation can in this respect take place as shown in FIG. 2, with now the filtering algorithm 21, however, carrying out the conversion of the data from the measuring unit 20 not arranged at the crane boom tip by means of virtual data on the position of the crane boom.

It is in this respect naturally possible to use both a first measuring unit MU 1 at the boom tip and a second measuring unit MU 2 at the tower or at the ship.

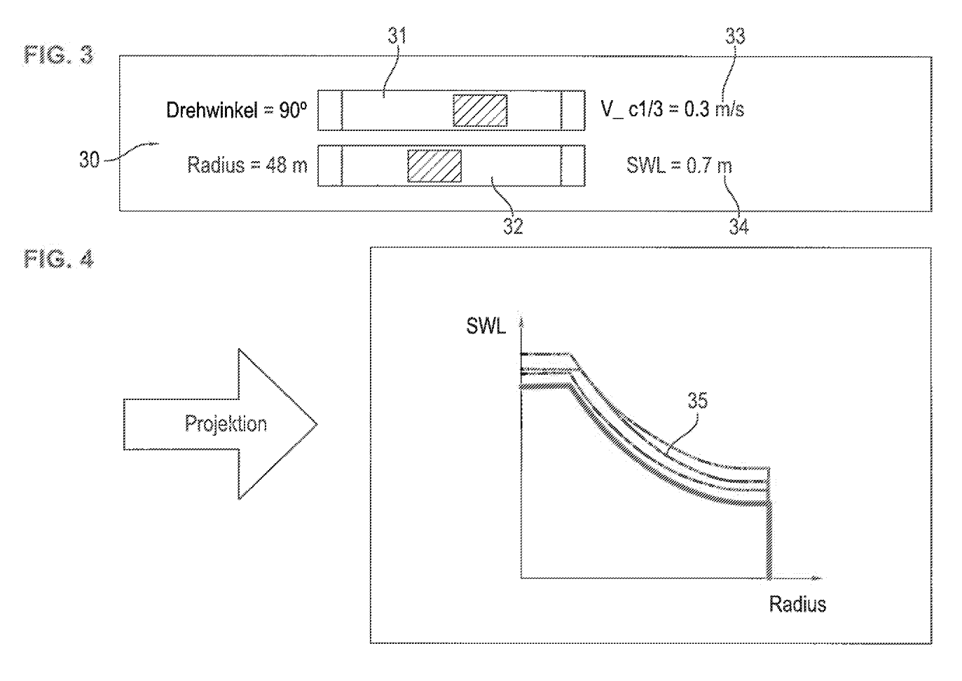

FIG. 3 in this respect shows an input/output unit via which any desired boom tip position can be moved to virtually. In this respect, the slew angle can be converted via the input mask 31; the radius via the input mask 32. The input can in this respect take place, for example, via a keyboard and/or virtual slider at a monitor or touch screen. The user interface now outputs the vertical tip speed for the set virtual position in the display 33 and the maximum payload SWL resulting from this in a display 34.

Alternatively or additionally, a display of the maximum payloads for the total working range can take place e.g. in the form of a payload curve. It must be taken into account in this respect that the maximum vertical speeds and thus the maximum permitted payloads for different slew angles of the crane can differ since the wave movement can, for example, result in a stronger movement of the ship in the transverse direction than in the longitudinal direction.

In order nevertheless to be able to give a payload curve which is valid for any desired slew angle of the crane, the following procedure can be followed:

First, the maximum vertical speed v_{C} is calculated for N different slew angles over the total outreach range. In a second step, the maximum payloads for the different slew angles are determined herefrom in dependence on the radius. The representation now takes place by projection of the maximum payloads for the different slew angles into a single graphic. Finally, the minimum can then be calculated over all slew angles and this is then represented as a maximum possible SWL in the form of a payload curve.

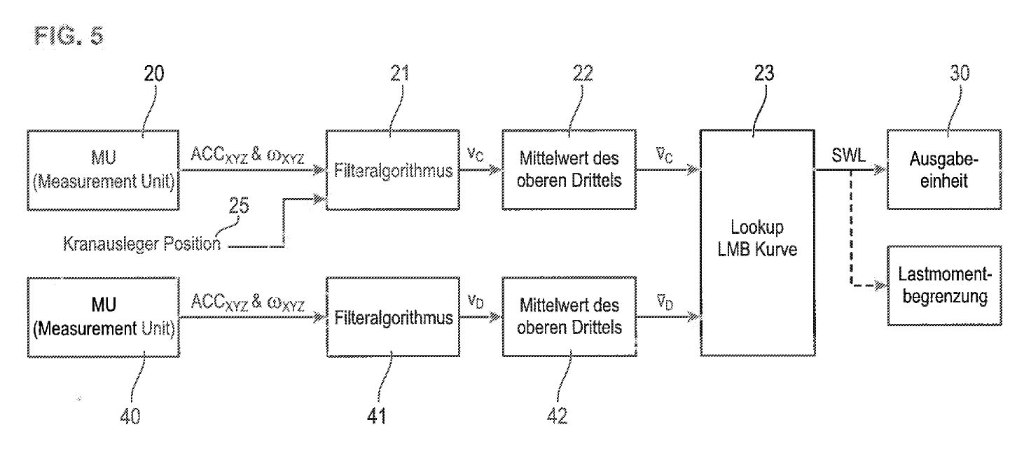

In this respect, in FIG. 4 an embodiment of such a display is shown in which a plurality of payload curves 35 are combined in one representation for different slew angles. Alternatively or additionally, the display of the Minimum can also be provided over all payload curves.

In all embodiments of the present invention, a new initializing of the determining of the movement of the boom tip takes place after a restart of the control. The starting results are in this respect always based on values since the restart of the control. All the data are in contrast not taken into account for the calculation.

The representation of the results can in this respect take place both in the crane control and on a diagnostic computer to be connected externally.

The above embodiments in this respect related to the case v_{D}=0, that is the work with a fixed destination. If, in contrast, work should take place with a deck speed other than zero, that is with a further ship as a destination or starting point, the measured values of the third measuring unit MU 3 are used. The mode of operation in this respect substantially corresponds to the case already described above, with the look-up table 23, however, having a further input. In addition to the speed of the boom tip v_{C}, the deck speed v_{D} is then also used to read out the maximum permitted payload from the table 23 (cf. FIG. 5).

The evaluation of the measured data of the third measuring unit 40 in this respect takes place analogously to the evaluation of the data of the first or second measuring unit 20. A filtering algorithm 41 is provided for this purpose which determines the deck speed in the vertical direction v_{D} from the data of the measuring unit. In step 42, the mean value of the upper third is then determined from this. It is then taken into the determination of the maximum payload as the top value of the deck speed.

The display of the data on the user interface 30 can then take place as already represented above.

Instead of the speed in the vertical direction v_{C} or v_{D} used in the embodiment, alternatively or additionally, the acceleration in the vertical direction a_{C} or a_{D} can also be used for determining the maximum permitted payload. The evaluation of the measured results can in this respect take place in the same manner as for the speed.

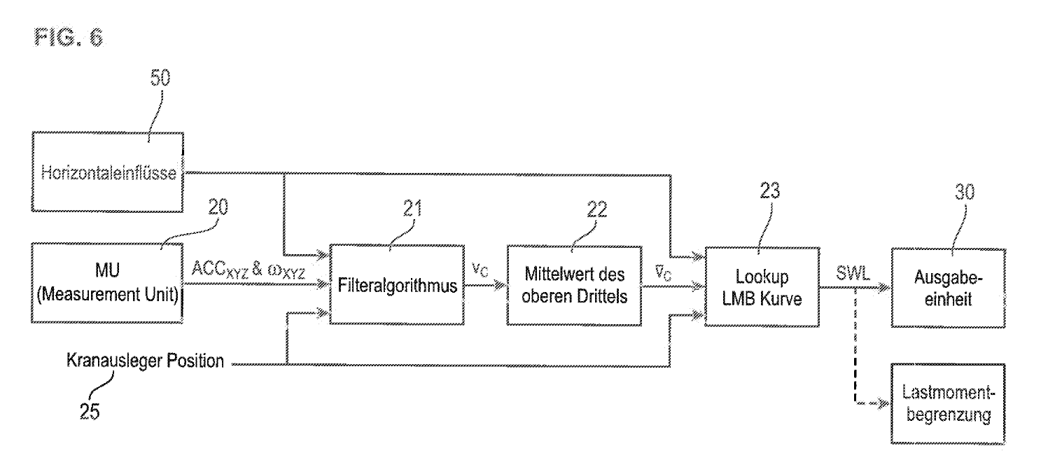

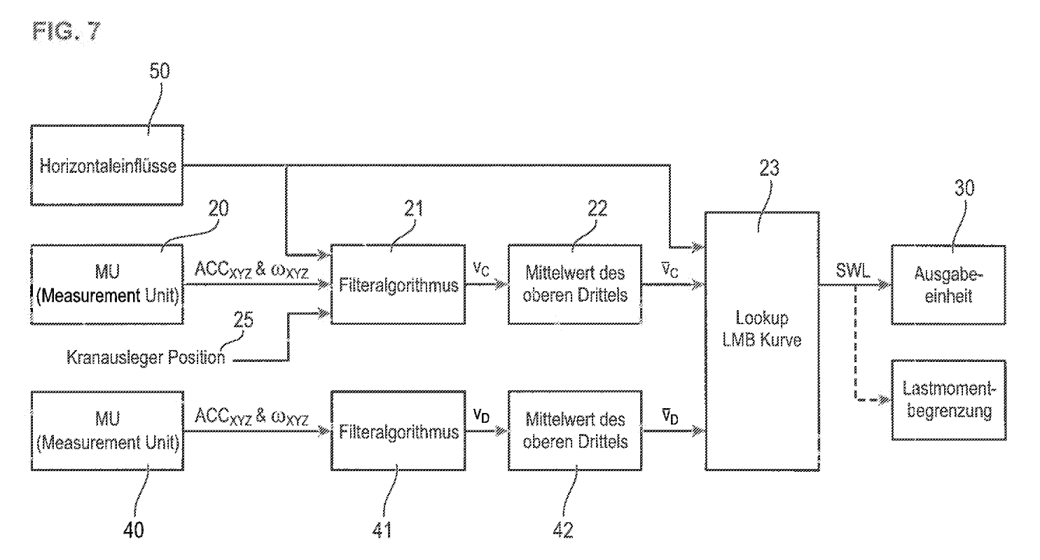

Evaluation routines analog to those in accordance with FIGS. 4 and 5 are shown in FIGS. 6 and 7. The horizontal influences are additionally taken into account in step 50. They can be based on an inclined position of the ship resulting from the load state or from a pre-trim. Dynamic horizontal deflections of the load caused by relative horizontal movements of the installations (ship with crane, ship where the load decreases and increases) are also taken into account here. In this respect, the horizontal influences can be measured or calculated. The values can be taken into account in the payloads by tables or by online calculation

The present invention makes it possible by the use of measured values of the ship's movement to use a crane employed on a ship despite the movement of the ship produced by the wave movement and thus to use the crane reliably and with high payloads.

In this respect, any floating body which is thus exposed to a wave movement can be considered a ship in the sense of the present invention. The present invention can therefore also be used with cranes which are arranged on barges or other floating bodies.

1. A crane control for a crane arranged on a ship having a load moment limitation system which determines a maximum permitted payload, wherein
the load moment limitation apparatus is in communication with a measuring unit for measuring the movement of the ship; and
the maximum permitted payload is determined on the basis of data of the measuring unit.

2. A crane control in accordance with claim 1, wherein the load moment limitation system determines a speed and/or acceleration of the boom tip, in particular in the vertical direction, by the evaluation of data of the measuring unit for measuring the movement of the ship and determines the maximum permitted payload from this, with the determination advantageously taking place on the basis of data of a respectively preceding defined time period.

3. A crane control in accordance with claim 1 2, wherein the load moment limitation system determines a tip speed and/or tip acceleration of the boom tip over a specific time period, with the load moment limitation system advantageously forming a mean value of the speed and/or acceleration of the boom tip over the specific time period and the mean value formation advantageously taking place over an upper part region of the speeds and/or accelerations determined by the measuring unit.

4. A crane control in accordance with claim 1, wherein the maximum permitted payload is read out of a table with reference to a speed value and/or acceleration value determined from the data of the measuring unit or is calculated online.

5. A crane control in accordance with claim 1, wherein the horizontal influences are measured and/or calculated in order then to be taken into account in the payload calculation by tables or by an online calculation.

6. A crane control in accordance with claim 1, wherein the measuring unit is arranged at the crane tip, or a determination of the speed and/or acceleration of the boom tip takes place for a specific boom position by conversion of data of a measuring unit not arranged in this position, with the measuring unit advantageously being arranged at the tower of the crane or at the ship and/or with the determination advantageously taking place for a boom position which can be input by the user.

7. A crane control in accordance with claim 1, wherein the load moment limitation system is in communication with a further measuring unit which determines the movement of a further ship; and the load moment limitation system makes use of additional data of the further measuring unit for determining the maximum permitted payload.

8. A crane control in accordance with claim 1 having an output unit, in particular an optical output unit which outputs the maximum payload calculated by the load moment limitation system, with the output advantageously taking place for a specific boom position, in particular input by the user, and/or as a payload curve.

9. A crane control in accordance with claim 1, wherein the measuring unit is an inertia measuring system or a GPS system.

10. A ship having a crane control in accordance with claim 1.

11. A method for operating a crane arranged on a ship, in particular for operating a crane in accordance with claim 8, in which a maximum permitted payload is determined, wherein
a movement of the ship is measured; and
the maximum permitted payload is determined on the basis of the measured movement.

12. A program, in particular a program stored on a data carrier, for implementing a method in accordance with claim 9 on a crane control.

13. A crane control in accordance with claim 2, wherein the load moment limitation system determines a tip speed and/or tip acceleration of the boom tip over a specific time period, with the load moment limitation system advantageously forming a mean value of the speed and/or acceleration of the boom tip over the specific time period and the mean value formation advantageously taking place over an upper part region of the speeds and/or accelerations determined by the measuring unit.

14. A crane control in accordance with claim 13, wherein the maximum permitted payload is read out of a table with reference to a speed value and/or acceleration value determined from the data of the measuring unit or is calculated online.

15. A crane control in accordance with claim 3, wherein the maximum permitted payload is read out of a table with reference to a speed value and/or acceleration value determined from the data of the measuring unit or is calculated online.

16. A crane control in accordance with claim 2, wherein the maximum permitted payload is read out of a table with reference to a speed value and/or acceleration value determined from the data of the measuring unit or is calculated online.

17. A crane control in accordance with claim 16, wherein the horizontal influences are measured and/or calculated in order then to be taken into account in the payload calculation by tables or by an online calculation.

18. A crane control in accordance with claim 15, wherein the horizontal influences are measured and/or calculated in order then to be taken into account in the payload calculation by tables or by an online calculation.

19. A crane control in accordance with claim 14, wherein the horizontal influences are measured and/or calculated in order then to be taken into account in the payload calculation by tables or by an online calculation.

20. A crane control in accordance with claim 13, wherein the horizontal influences are measured and/or calculated in order then to be taken into account in the payload calculation by tables or by an online calculation.
